(19) United States
(12) Patent Application Publication
(10) Pub. No.: US 2019/0200107 A1
(43) Pub. Date: Jun. 27, 2019

(54) CRADLE DEVICE FOR HOLDING A PORTABLE DEVICE

(71) Applicant: Rebel Poppy Pty Ltd, Kenthurst (AU)

(72) Inventors: Mark Crandon, Kenthurst (AU); Rebecca Paros, Kenthurst (AU); James Paros, Kenthurst (AU)

(21) Appl. No.: 16/288,120

(22) Filed: Feb. 28, 2019

(51) Int. Cl. H04R 1/02; F16M 13/02

(52) U.S. Cl. CPC H04R 1/02; A45F 5/00; A45F 2200/0516; F16M 13/02

(57) ABSTRACT

Embodiments of the present disclosure provides a cradle device and mirror-cradle systems for holding a portable device at a time when a user wants to use the portable device while being involved in other task. A cradle device includes a holding apparatus for receiving and securely holding the portable device. The cradle device further includes at least one attachment unit configured to detachably connect the holding apparatus to a surface. The at least one attachment unit further includes at least two supporting apparatus including a first supporting apparatus and a second supporting apparatus. The cradle device furthermore includes at least one hole for coupling the attachment unit to the surface.

### TECHNICAL FIELD

The presently disclosed subject matter generally relates to the field of accessories for portable devices/electronic devices. Particularly, the present subject matter relates to a cradle device configured to hold a portable device like a mobile phone, a tablet computer, etc.

### BACKGROUND

Computing devices like mobile phone, tablet computers like I pads etc., has become an integral part of almost everyone day-to-day life. People use these computing devices for making calls, messaging, entertainment, music, and so forth. Some people use the computing device like mobile phones for their professional work and may require carrying the computing device everywhere.

Also these days people like to multitask, for example, while working on a computer people like listening to the music via earphones connected to mobile phones or the computer, checking their social networking account or playing a game on the mobile phone while hearing music, and so forth. Sometimes, handling or holding the mobile phone while doing other tasks sometimes becomes difficult for the person and many times the mobile phones fall out of the hand. This may damage the mobile phones that can sometime leave them useless after the fall. In some scenarios, a user may want to use his/her mobile phone while doing makeup or getting his/her makeup done by others. For example, the user may want to watch a video or have a video call on the mobile phone while having his/her makeup done. Many artists spend hours of their day in makeup chair just getting bored as other person is doing their makeup. They would want to do something on their mobile phones or devices but are not able to do, as they have to keep looking in the mirror.

In light of above discussion, there exists need for holding devices for holding the computing device, while the user is multi-tasking or when a user wants to use the computing device while doing other task.

### SUMMARY

The main objective of the present disclosure is to provide a cradle system or a cradle device and methods of its use, for holding a mobile computing device or a portable device when a user wants to use the mobile computing device when the user is involved in multiple tasks at a time.

The present disclosure provides a cradle device for holding and securing a mobile computing device.

The present disclosure provides a mirror-cradle system for holding a portable device at a time when a user wants to use the portable device while doing other task.

The present disclosure provides a cradle device for holding a mobile computing device at a time when a user wants to use the mobile computing device while being involved in other task like getting makeup done.

An embodiment of the present disclosure provides a cradle device including a holding apparatus and at least one attachment unit. The holding apparatus is configured to receive a portable device. The at least one attachment unit is configured to couple the holding apparatus to a surface.

According to an aspect of the present disclosure, the surface includes a mirror.

According to another aspect of the present disclosure, the portable device is a mobile computing device including at least one of a mobile phone, a cellular device, a tablet computer, a personal digital assistant (PDA), a fitness-tracking device, a camera, and a screen.

According to another aspect of the present disclosure, the at least one attachment unit includes at least one hole for attaching the cradle device to the surface such that a user is able to use the portable device while doing other task.

According to another aspect of the present disclosure, the at least one attachment unit including at least two supporting apparatus comprising a first supporting apparatus and a second supporting apparatus.

According to another aspect of the present disclosure, the first supporting apparatus is configured to couple the cradle device with the surface.

According to another aspect of the present disclosure, the second supporting apparatus is configured to couple with the received portable device.

According to yet another aspect of the present disclosure the cradle device is formed using a material including at least one of plastic, silicon, rubber, wood, metal, Styrofoam, and fiber.

Another embodiment of the present disclosure provides a mirror-cradle system for holding a portable device at a time when a user wants to use the portable device while doing other task. The mirror-cradle system includes a holding apparatus for receiving and securely holding the portable device. The mirror-cradle system also includes at least one attachment unit configured to couple the holding apparatus to a mirror surface. The at least one attachment unit further includes at least two supporting apparatus comprising a first supporting apparatus and a second supporting apparatus.

According to an aspect of the present disclosure, the at least one attachment unit includes at least one hole for coupling with the mirror surface.

According to another aspect of the present disclosure, the first supporting apparatus is configured to couple with the mirror surface.

According to another aspect of the present disclosure, the second supporting apparatus is configured to couple with the received portable device.

According to another aspect of the present disclosure, the mirror-cradle system is formed using a material such as, but not limited to, plastic, silicon, rubber, wood, metal, Styrofoam, and fiber.

A yet another embodiment of the present disclosure provides a cradle device for holding a mobile computing device at a time when a user wants to use the mobile computing device while being involved in other task. The cradle device includes a holding apparatus for receiving and securely holding the mobile computing device. The cradle device further includes at least one attachment unit configured to detachably connect the holding apparatus to a surface. The at least one attachment unit further includes at least two supporting apparatus including a first supporting apparatus and a second supporting apparatus. The cradle device furthermore includes at least one hole for coupling the attachment unit to the surface.

According to another aspect of the present disclosure, the first supporting apparatus is configured to couple with the surface.

According to another aspect of the present disclosure, the second supporting apparatus is configured to secure the mobile computing device into the holding apparatus.

According to another aspect of the present disclosure, the surface includes any suitable a flat surface.

According to another aspect of the present disclosure, the surface comprising a mirror surface.

According to yet another aspect of the present disclosure, the cradle device is formed using a material including at least one of plastic, silicon, rubber, wood, metal, Styrofoam, and fiber.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the disclosed subject matter will be best understood by reference to the drawings, wherein like parts are designated by like numerals throughout. The following description is intended only by way of example, and simply illustrates certain selected embodiments of devices, systems, and processes that are consistent with the disclosed subject matter as claimed herein.

FIG. 1 illustrates an exemplary cradle device, in accordance with an embodiment of the present disclosure.

FIG. 2 illustrates another exemplary cradle device, in accordance with another embodiment of the present disclosure.

FIG. 3 illustrates an exemplary environment in which the cradle device of FIG. 1 can be used, in accordance with an embodiment of the present disclosure.

FIG. 4 illustrates an exemplary environment in which the cradle device of FIG. 2 can be used, in accordance with an embodiment of the present disclosure.

FIG. 5A illustrates a front view of an exemplary cradle device, in accordance with an embodiment of the present disclosure.

FIG. 5B illustrates a back view of the exemplary cradle device of the FIG. 5A, in accordance with an embodiment of the present disclosure.

FIGS. 5C-5D illustrates top views of the exemplary cradle device of the FIG. 5A from different angles, in accordance with an embodiment of the present disclosure.

FIG. 5E illustrates a left side view of the exemplary cradle device of the FIG. 5A, in accordance with an embodiment of the present disclosure.

FIG. 5F illustrates a right side view of the exemplary cradle device of the FIG. 5A, in accordance with an embodiment of the present disclosure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Reference throughout this specification to “a select embodiment,” “one embodiment,” or “an embodiment” means that a particular feature, structure, or characteristic described in connection with the embodiment is included in atleast one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

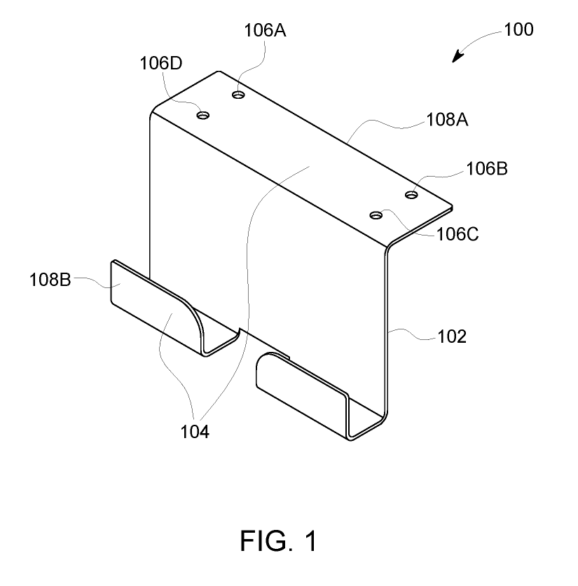

FIG. 1 illustrates an exemplary cradle device 100, in accordance with an embodiment of the present disclosure. The cradle device 100 may also be referred as a mirror-cradle system 100. The cradle device 100 can be attached to a surface. In some embodiments, the cradle device 100 is attached to any suitable surface that is substantially flat. In a non-limiting example, the surface is a mirror surface. In some embodiments, the cradle device 100 is detachably attached to any suitable surface. The cradle device 100 is configured to receive and hold a portable device (hereinafter, the portable device may also be referred as a mobile computing device or a mobile device). A user can comfortably secure his/her portable device and can use the portable device secured in the cradle device 100. For example, the user can watch a video, do a video call, and listen to music without requiring holding the portable device in his/her hands. The cradle device 100 enables the user to use his/her portable device while being involved in other task(s).

As shown, the cradle device 100 includes a holding apparatus 102 configured to receive a portable device such that a user is able to use the portable device while doing other task. The portable device may be a mobile computing device. Examples of the portable device may include, but are not limited to, a mobile phone, a cellular device, a tablet computer, a personal digital assistant (PDA), a fitness-tracking device, a camera, a smart phone, and a display device.

The cradle device 100 also includes at least one attachment unit 104 configured to couple the holding apparatus 102 to a surface. In some embodiments, the surface includes a mirror. In some embodiments, the at least one attachment unit 104 is configured to detachably connect the holding apparatus 102 to the surface. Further, the at least one attachment unit 104 includes at least two supporting apparatus comprising a first supporting apparatus 108A and a second supporting apparatus 108B. The first supporting apparatus 108A is configured to couple with the surface such as the mirror surface. The second supporting apparatus 108B is configured to couple with the portable device to secure the portable device in the cradle device 100. Further, the second supporting apparatus 108B is configured to secure the portable device into the holding apparatus 104. The second supporting apparatus 108B may prevent the portable device from falling out of the cradle device 100. In some embodiments, the second supporting apparatus 108B may include two parts. In alternative embodiments, the second supporting apparatus 108B may be a one single part.

In some embodiments, the at least one attachment unit 104 further includes at least one hole for attaching the cradle device 100 to the surface such that a user is able to use the portable device while doing other task. As shown, the first supporting apparatus 108A includes four holes 106A, 106B, 106C, and 106D. The cradle device 100 may be attached to the surface by using a plurality of screws in the holes 106A-106D. The holes 106A-106D are configured to receive four screws respectively so as to attach to the surface.

The cradle device 100 may be formed using a suitable material such as, but not limited to, plastic, silicon, rubber, wood, metal, Styrofoam, and fiber. Further, a size and shape of the cradle device 100 may vary depending on the shape and size of the portable device.

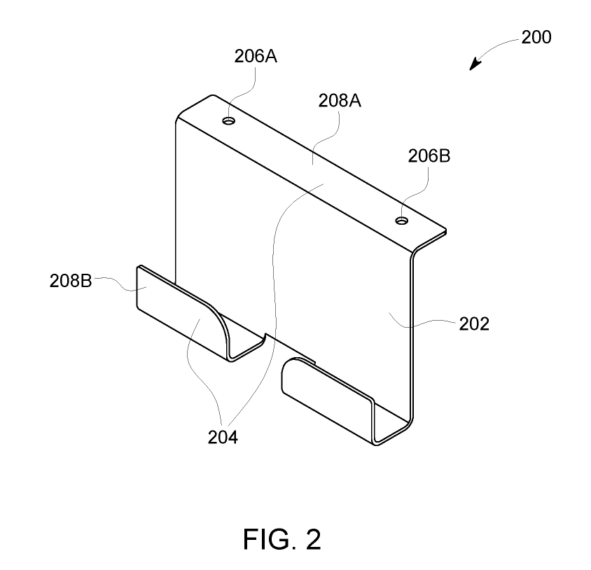

FIG. 2 illustrates another exemplary cradle device 200, in accordance with another embodiment of the present disclosure. As shown, the cradle device 200 includes holding apparatus 202 configured to receive a portable device such that a user is able to use the portable device while doing other task(s). The portable device may be a mobile computing device. Examples of the portable device may include, but are not limited to, a mobile phone, a tablet computer, a cellular device, a personal digital assistant (PDA), a fitness-tracking device, a camera, a smart phone, and a display device.

Further, the cradle device 200 includes at least one attachment unit 204 configured to couple the holding apparatus 202 to a surface. In some embodiments, the surface includes a mirror. In some embodiments, the at least one attachment unit 204 is configured to detachably connect the holding apparatus 202 to the surface. Further, the at least one attachment unit 204 includes at least two supporting apparatus comprising a first supporting apparatus 208A and a second supporting apparatus 208B. The first supporting apparatus 208A is configured to couple with the surface such as the mirror surface. The second supporting apparatus 208B is configured to couple with the portable device to secure the portable device in the cradle device 200. The second supporting apparatus 208B is configured to secure the mobile computing device/portable device into the holding apparatus 202. The second supporting apparatus 208B may prevent the portable device from falling out of the cradle device 200. In some embodiments, the second supporting apparatus 208B may include two parts. In alternative embodiments, the second supporting apparatus 208B may be a one single part.

In some embodiments, the at least one attachment unit 204 further includes at least one hole for attaching to the surface. As shown, the first supporting apparatus 208A includes two holes 206A and 206B for receiving two screws. The cradle device 200 may be attached to the surface by using two screws in the holes 206A-206B. The holes 206A-206B are configured to receive two screws respectively so as to attach to the surface.

The cradle device 200 may be formed using a suitable material such as, but not limited to, plastic, silicon, rubber, wood, metal, Styrofoam, and fiber. Further, a size and shape of the cradle device 200 may vary depending on the shape and size of the portable device.

The cradle device 200 may also be referred as a mirror-cradle system 200. The cradle device 200 can be attached to a surface. In some embodiments, the cradle device 200 is attached to any suitable surface that is substantially flat. In a non-limiting example, the surface is a mirror surface. In some embodiments, the cradle device 200 is detachably attached to any suitable surface. In some embodiments, the surface may include a frame surface, a display surface, a window, and so forth. The cradle device 200 is configured to receive and hold the portable device (hereinafter, the portable device may also be referred as a mobile computing device or a mobile device). A user can comfortably secure his/her portable device and can use the portable device secured in the cradle device 200. For example, the user can watch a video, do a video call, and listen to music without requiring holding the portable device in his/her hands. The cradle device 200 enables the user to use his/her portable device while being involved in other task(s).

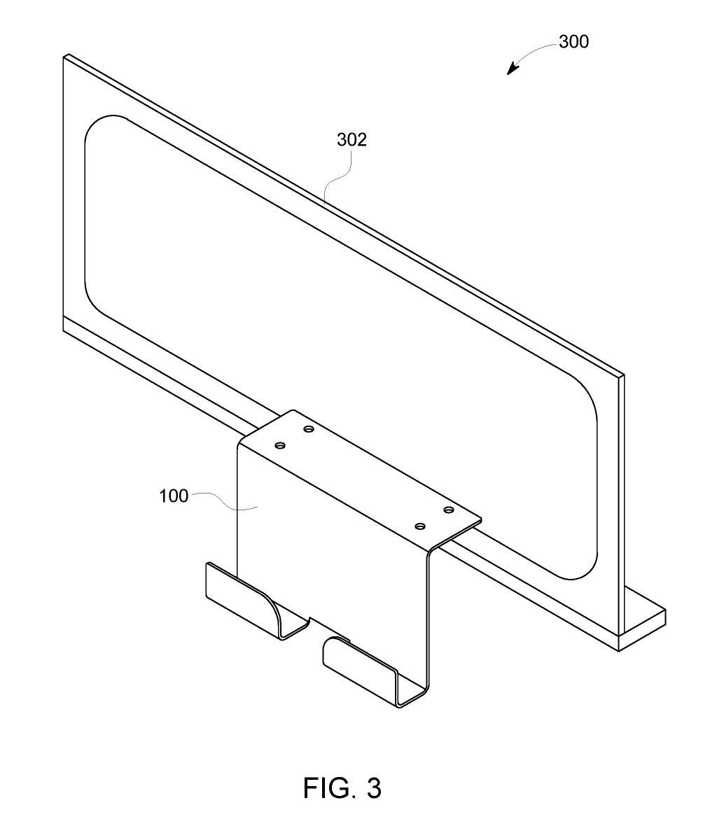

FIG. 3 illustrates an exemplary environment 300 in which the cradle device 100 of FIG. 1 can be used, in accordance with an embodiment of the present disclosure. The cradle device 100 can be attached to any suitable surface 302. Examples of the surface 302 may include, but are not limited to, a mirror surface, a photo frame, a television, a table, a door, and so forth. The cradle device 100 includes the four holes 106A-106D through which the cradle device 100 can be attached to the surface 302. The holes 106A-106D are configured to receive four screws respectively so as to attach to the surface 302. In some embodiments, the suitable screws may be used in the holes 106A-106D for attaching the cradle device 100 to the surface 402. After attaching the cradle device 100 to the surface 302, a user can put a mobile computing device like a phone in the cradle device 100 and may use the mobile computing device comfortably without engaging his/her hands all the time.

FIG. 4 illustrates an exemplary environment 400 in which the cradle device 200 of FIG. 2 can be used, in accordance with an embodiment of the present disclosure. The cradle device 200 can be attached to a suitable surface 402. Examples of the surface 302 may include, but are not limited to, a mirror surface, a photo frame, a television, a table, a door, and so forth. The cradle device 200 includes the two holes 206A-206B through which the cradle device 200 can be attached to the surface 402. The holes 206A-206B are configured to receive two screws respectively so as to attach to the surface 402. In some embodiments, the suitable screws may be used in the holes 206A-206B for attaching the cradle device 200 to the surface 402. After attaching the cradle device 200 to the surface 402, a user can put a mobile computing device like a phone in the cradle device 200 and may use the mobile computing device comfortably without engaging his/her hand(s) all the time.

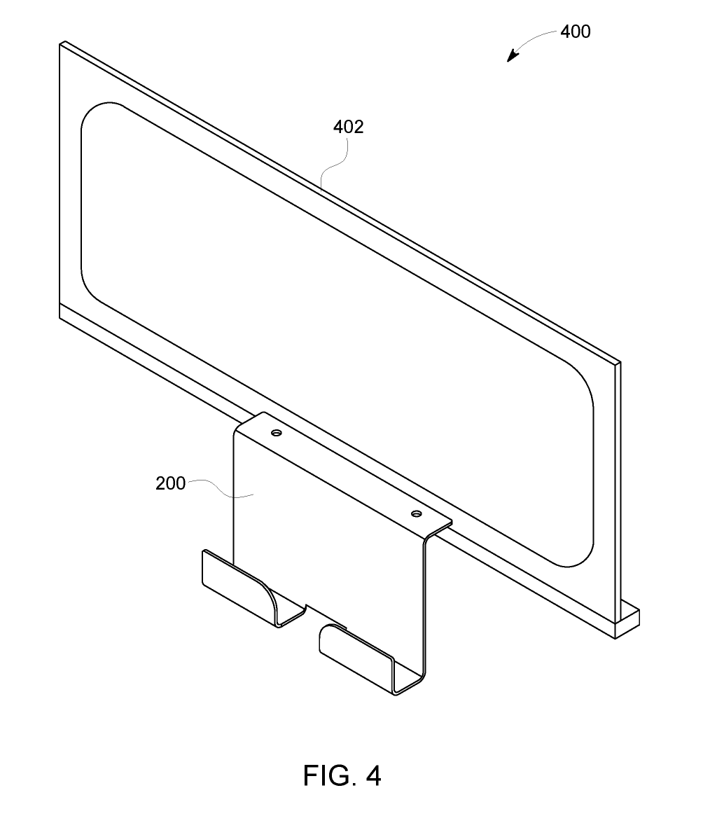

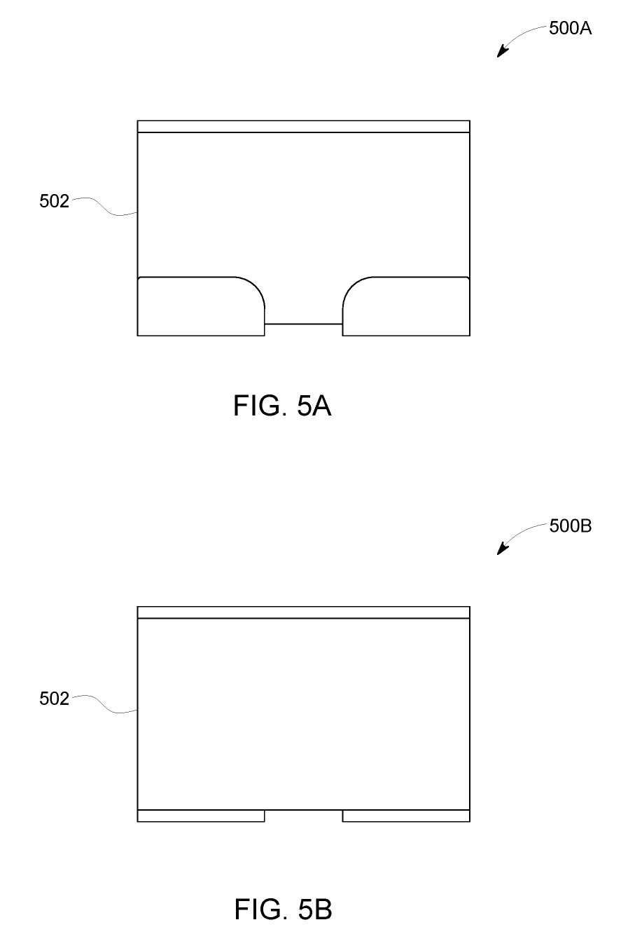

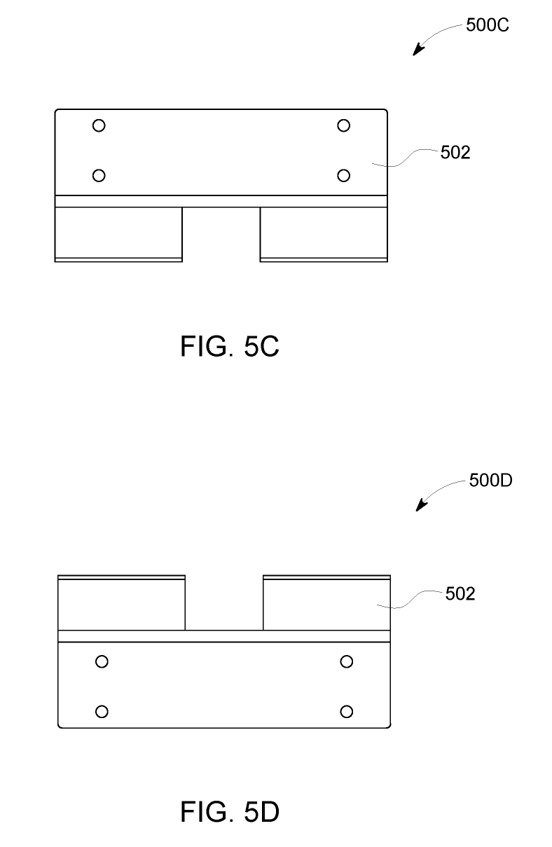

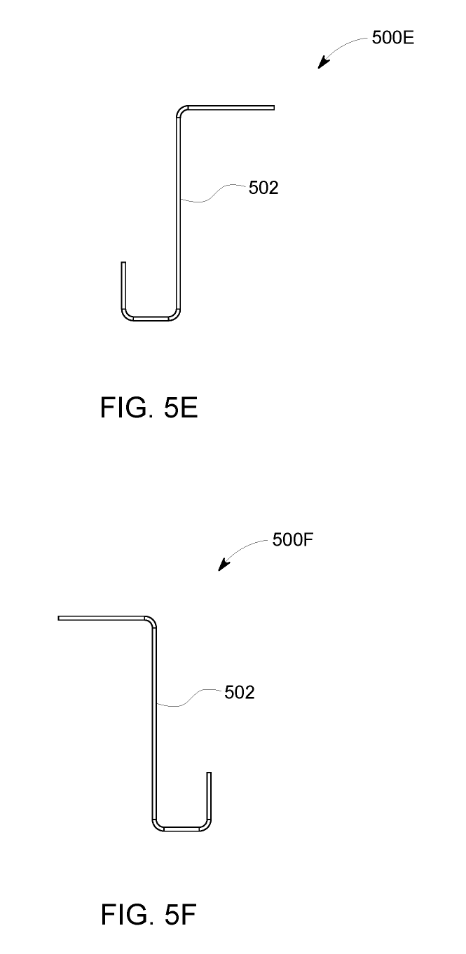

FIG. 5A illustrates a front view 500A of an exemplary cradle device 502, in accordance with an embodiment of the present disclosure. The cradle device 502 may also be referred as a mirror-cradle system. The cradle device 502 includes a holding apparatus for receiving and securely holding the portable device. The cradle device 502 also includes at least one attachment unit configured to couple the holding apparatus to a surface such as the mirror surface. The at least one attachment unit may further include at least two supporting apparatus i.e. a first supporting apparatus and a second supporting apparatus. The first supporting apparatus is configured to couple with the surface. The second supporting apparatus is configured to couple with the portable device to secure the portable device. The second supporting apparatus is configured to secure the portable device into the holding apparatus.

In some embodiments, the at least one attachment unit includes one or more holes for coupling the cradle device to the surface or the mirror surface. The holes are configured to receive one or more screws or other suitable structures for attaching the cradle device to the surface. The cradle device can be detached from the surface by unscrewing the screws.

FIG. 5B illustrates a back view 500B of the exemplary cradle device 502 of the FIG. 5A, in accordance with an embodiment of the present disclosure. The cradle device 502 is configured to receive and hold a portable device. The portable device is a mobile computing device comprising at least one of a mobile phone, a cellular device, a tablet computer, a personal digital assistant (PDA), a fitness-tracking device, a camera, and a display device.

FIGS. 5C-5D illustrates a top view 500C and a top view 500D of the exemplary cradle device 502 of the FIG. 5A from different angles, in accordance with some embodiments of the present disclosure. The cradle device 502 may be formed using a suitable material including, but not limited to, at least one of plastic, silicon, rubber, wood, metal, Styrofoam, and fiber.

FIG. 5E illustrates a left side view 500E of the exemplary cradle device 502 of the FIG. 5A, in accordance with an embodiment of the present disclosure. FIG. 5F illustrates a right side view 500F of the exemplary cradle device 502 of the FIG. 5A, in accordance with an embodiment of the present disclosure. In an example, the cradle device 502 may receive and hold at least one of a smart mobile phone, a tablet computer, music devices like IPod, fitness-tracking devices, and other portable device for a user at a time of grooming or make-up of a user. The cradle device 502 can be detachably attached to the mirror surface to provide support in holding the portable device such that user can use the portable device while doing make-up or personal grooming.

The disclosed cradle device includes a holding apparatus and at least one attachment unit. The holding apparatus is configured to receive a portable device such that a user is able to use the portable device while doing other task. The at least one attachment unit is configured to couple the holding apparatus to a surface.

The disclosed cradle device can be used with mirror of any design or sizes. The size and shape of the cradle device may vary depending on a size and shape of the mirror and a portable device.

In some embodiments of the present disclosure, the at least one attachment unit includes at least two supporting apparatus including a first supporting apparatus and a second supporting apparatus.

In some embodiments of the present disclosure, the first supporting apparatus is configured to couple with the surface.

In some embodiments of the present disclosure, the second supporting apparatus is configured to couple with the received portable device.

In some embodiments of the present disclosure the cradle device is formed using a material including at least one of plastic, silicon, rubber, wood, metal, Styrofoam, and fiber.

The disclosed mirror-cradle system can be used for holding a portable device at a time when a user wants to use the portable device while doing other task. The mirror-cradle system includes a holding apparatus for receiving and securely holding the portable device. The mirror-cradle system also includes at least one attachment unit configured to couple the holding apparatus to a mirror surface. The at least one attachment unit further includes at least two supporting apparatus comprising a first supporting apparatus and a second supporting apparatus.

In some embodiments of the present disclosure, the at least one attachment unit includes at least one hole for coupling with the mirror surface.

In some embodiments, the first supporting apparatus is configured to couple with the mirror surface.

In some embodiments, the second supporting apparatus is configured to couple with the received portable device.

In some embodiments, the mirror-cradle system is formed using any suitable material such as, but not limited to, plastic, silicon, rubber, wood, metal, Styrofoam, and fiber.

The disclosed cradle device or cradle system can be used for holding a mobile computing device at a time when a user wants to use the mobile computing device while being involved in other task. The cradle device includes a holding apparatus for receiving and securely holding the mobile computing device. The cradle device further includes at least one attachment unit configured to detachably connect the holding apparatus to a surface. The at least one attachment unit further includes at least two supporting apparatus including a first supporting apparatus and a second supporting apparatus. The cradle device furthermore includes at least one hole for coupling the attachment unit to the surface.

The present disclosure also provides a method of holding a portable device securely. The method includes providing a cradle device including a holding apparatus for receiving and holding the portable device. The cradle device also includes an attachment unit for attaching the holding apparatus to a surface. The method also includes receiving the portable device in the cradle device.

By using the disclosed cradle device, a user can save his/her portable device from damage. As while multi-tasking, the user can use the portable device without a fear of falling of the portable device. The user can comfortably use the portable device and at the same time may get involved with other tasks like makeup and grooming.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The terminology used herein is for the purpose of describing particular embodiments only and is not intended to be limiting of the disclosure. It will be appreciated that several of the above disclosed and other features and functions, or alternatives thereof, may be combined into other systems, methods, or applications. Various presently unforeseen or unanticipated alternatives, modifications, variations, or improvements therein may subsequently be made by those skilled in the art without departing from the scope of the present disclosure as encompassed by the following claims.

What is claimed is:

1. A cradle device comprising:
a holding apparatus configured to receive a portable device; and
at least one attachment unit configured to couple the holding apparatus to a surface.

2. The cradle device of claim 1, wherein the surface comprises a mirror surface.

3. The cradle device of claim 1, wherein the portable device is a mobile computing device comprising at least one of a mobile phone, a tablet computer, a cellular device, a personal digital assistant (PDA), a fitness-tracking device, a camera, and a display device.

4. The cradle device of claim 1, wherein the at least one attachment unit comprising at least one hole for attaching the cradle device to the surface such that a user is able to use the portable device while doing other task.

5. The cradle device of claim 1, wherein the at least one attachment unit comprising at least two supporting apparatus comprising a first supporting apparatus and a second supporting apparatus.

6. The cradle device of claim 6, wherein the first supporting apparatus is configured to couple the cradle device to the surface.

7. The cradle device of claim 6, wherein the second supporting apparatus is configured to couple with the received portable device.

8. The cradle device of claim 1, wherein the cradle device is formed using a material comprising at least one of plastic, silicon, rubber, wood, metal, Styrofoam, and fiber.

9. A mirror-cradle system for holding a portable device, comprising:
a holding apparatus for receiving and securely holding the portable device; and
at least one attachment unit configured to couple the holding apparatus to a mirror surface, wherein the at least one attachment unit comprising at least two supporting apparatus comprising a first supporting apparatus and a second supporting apparatus.

10. The mirror-cradle system of claim 9, wherein the at least one attachment unit comprising at least one hole for coupling the cradle device to the mirror surface.

11. The mirror-cradle system of claim 9, wherein the portable device is a mobile computing device comprising at least one of a mobile phone, a tablet computer, a cellular device, a personal digital assistant (PDA), a fitness-tracking device, a camera, and a display device.

12. The mirror-cradle system of claim 9, wherein the first supporting apparatus is configured to couple with the mirror surface.

13. The mirror-cradle system of claim 9, wherein the second supporting apparatus is configured to couple with the portable device to secure the portable device.

14. The mirror-cradle system of claim 9, wherein the mirror-cradle system is formed using a material comprising at least one of plastic, silicon, rubber, wood, metal, Styrofoam, and fiber.

15. A cradle device for holding a mobile computing device at a time when a user wants to use the mobile computing device while being involved in other task, comprising:
a holding apparatus for receiving and securely holding the mobile computing device;
at least one attachment unit configured to detachably connect the holding apparatus to a surface, wherein the at least one attachment unit comprising at least two supporting apparatus comprising a first supporting apparatus and a second supporting apparatus; and
at least one hole for coupling the attachment unit to the surface.

16. The cradle device of claim 15, wherein the first supporting apparatus is configured to couple with the surface.

17. The cradle device of claim 15, wherein the second supporting apparatus is configured to secure the mobile computing device into the holding apparatus.

18. The cradle device of claim 15, wherein the surface comprising a flat surface.

19. The cradle device of claim 15, wherein the surface comprising a mirror surface.

20. The cradle device of claim 15, wherein the cradle device is formed using a material comprising at least one of plastic, silicon, rubber, wood, metal, Styrofoam, and fiber.
